(19) United States
(12) Patent Application Publication
(10) Pub. No.: US 2020/0110480 A1
(43) Pub. Date: Apr. 9, 2020

(54) TOUCH PANELS, MANUFACTURING METHODS THEREOF, AND DISPLAY DEVICES

(71) Applicant: Yungu (Gu'an) Technology Co., Ltd., Langfang (CN)

(72) Inventors: Guizhou Qiao, Langfang (CN); Jiangping Hu, Langfang (CN); Jianping Chen, Langfang (CN); Xiuyu Zhang, Langfang (CN); Weiguo Li, Langfang (CN); Shengzu Zhu, Langfang (CN); Suhua Li, Langfang (CN)

(21) Appl. No.: 16/702,588

(22) Filed: Dec. 4, 2019

Related U.S. Application Data
(63) Continuation of application No. PCT/CN2018/119006, filed on Dec. 3, 2018.

(30) Foreign Application Priority Data
Jun. 30, 2018 (CN) 201810703689.2

(51) Int. Cl. G06F 3/041

(52) U.S. Cl. CPC G06F 3/041; G06F 2203/04103

(57) ABSTRACT

The present application discloses a touch panel, a manufacturing method thereof, and a display device. In the touch panel, a portion of an adhesion enhancement layer on a second region contains a conductive material, so that a contact resistance between a wiring layer and a nano-metal layer can be reduced, which is advantageous for increasing the electric conductivity of the touch panel, thereby improving the touch control effect of the touch panel. Furthermore, since the portion of the adhesion enhancement layer on the second region contains a conductive material to enhance the electric conductivity of the touch panel, a contact area between the wiring layer and the adhesion enhancement layer can be reduced appropriately while maintaining the same electric conductivity, and the size of the bezel area of the touch panel can be reduced correspondingly.

### CROSS-REFERENCES TO RELATED APPLICATIONS

The present application is a continuation application to PCT Application No. PCT/CN2018/119006, filed on Dec. 3, 2018, which claims priority to Chinese Patent Application No. 201810703689.2, filed on Jun. 3, 2018. Both applications are incorporated by reference herein for all purposes.

### TECHNICAL FIELD

The present application relates to the field of display technology.

### BACKGROUND

Touch panels are widely used, and they are typically implemented with touch electrodes. Touch electrodes of conventional touch panels are usually made of indium tin oxide (ITO). Unfortunately, conventional touch panels are often inadequate for various reasons.

### SUMMARY

The technical problem to be solved by the present application is that the existing touch panels using metal nanowires as touch electrodes have defects of poor touch control effect and difficulty in meeting the design requirement for a narrow frame.

In order to solve the above technical problem, the present application provides a touch panel comprising: a substrate, having a first region and a second region located on a periphery of the first region; a nano-metal layer, located on the first region and the second region of the substrate; an adhesion enhancement layer, located on a side of the nano-metal layer away from the substrate and comprising a portion of the adhesion enhancement layer on the first region and a portion of the adhesion enhancement layer on the second region; and a wiring layer, located on a side of the portion of the adhesion enhancement layer on the second region away from the substrate; wherein the portion of the adhesion enhancement layer on the second region contains a conductive material.

Optionally, in the touch panel, the portion of the adhesion enhancement layer on the second region is an adhesion enhancement adhesive layer.

Preferably, in the touch panel, the adhesion enhancement adhesive layer is an optical adhesive layer.

Optionally, in the touch panel, the nano-metal layer is a silver nanowire layer.

Further, in the touch panel, the portion of the adhesion enhancement layer on the second region is made to contain a conductive material by an ion implantation process.

Preferably, in the touch panel, an implanted element of the ion implantation process is selected from at least one of a transition metal element, a Group III element, and a Group V element.

Further, in the touch panel, the implanted element is selected from at least one of gold, silver, copper, boron, phosphorus, and arsenic.

Preferably, in the touch panel, the implanted element is arsenic.

According to another aspect of the present application, the present application provides a display device comprising the aforementioned touch panel.

According to still another aspect of the present application, the present application provides a method of manufacturing a touch panel, comprising: providing a substrate having a first region and a second region located on a periphery of the first region; forming a nano-metal layer on the first region and the second region of the substrate; forming an adhesion enhancement layer made of an insulation material on a side of the nano-metal layer away from the substrate; and forming a wiring layer on a side of a portion of the adhesion enhancement layer on the second region away from the substrate; and performing an ion implantation process to make the portion of the adhesion enhancement layer on the second region contain a conductive material.

Optionally, in the method of manufacturing the touch panel, the ion implantation process to make the portion of the adhesion enhancement layer on the second region contain a conductive material is performed before forming the wiring layer.

Optionally, in the method of manufacturing the touch panel, the ion implantation process to make the portion of the adhesion enhancement layer on the second region contain a conductive material is performed after forming the wiring layer.

Optionally, in the method of manufacturing the touch panel, the portion of the adhesion enhancement layer on the second region is an adhesion enhancement adhesive layer.

Preferably, the adhesion enhancement adhesive layer is an optical adhesive layer.

Optionally, in the method of manufacturing the touch panel, the nano-metal layer is a silver nanowire layer.

Furthermore, in the method of manufacturing the touch panel, an implanted element of the ion implantation process is selected from at least one of a transition metal element, a Group III element, and a Group V element.

Optionally, in the method of manufacturing the touch panel, the implanted element is selected from at least one of gold, silver, copper, boron, phosphorus, and arsenic.

Preferably, in the method of manufacturing the touch panel, the implanted element is arsenic.

Optionally, a doping concentration of the conductive material in the portion of the adhesion enhancement layer on the second region is controlled by a controllable energy adjustment to a doping source comprising an element to be implanted or by changing a dosage of a doping source comprising an element to be implanted.

As compared with prior art, the present application has the following beneficial effects:

In the touch panel provided by the present application, as a portion of the adhesion enhancement layer on the second region contains a conductive material, the contact resistance between the wiring layer and the nano-metal layer can be reduced, thereby enhancing the electric conductivity of the touch panel and improving the touch control effect of the touch panel. Furthermore, due to the enhanced electric conductivity of the touch panel, the contact area between the wiring layer and the adhesion enhancement layer can be appropriately reduced while maintaining the same electric conductivity, and the size of the bezel area of the touch panel is correspondingly reduced. Therefore, the touch panel can meet the design requirement for a narrow bezel, thereby meeting the market demand for a narrow frame of the display device.

In the touch panel provided by the present application, the portion of the adhesion enhancement layer on the second region is preferably an adhesion enhancement adhesive layer which is a transparent insulating adhesive layer. On the one hand, the adhesion enhancement adhesive layer enables the nano-metal layer to be better attached to the substrate, so that the nano-metal layer is less likely to shift, and the lap-joint between the nano-metal layer and the substrate is firmer; on the other hand, the good light transmittance of the adhesion enhancement adhesive layer can meet the requirement for light extraction.

In the touch panel provided by the present application, the nano-metal layer is preferably a silver nanowire layer, wherein the silver is in its normal state a silver white metal with excellent electric conductivity, which is suitable for improving the electric conductivity of the touch panel.

In the touch panel provided by the present application, the implanted element is preferably arsenic. Since arsenic is an element with a large relative atomic mass, the relative conductivity of the portion of the adhesion enhancement layer on the second region can be remarkably improved after performing the ion implantation process.

In the method of manufacturing the touch panel of the present application, the ion implantation process is performed to make the portion of the adhesion enhancement layer on the second region contain a conductive material, thereby reducing the contact resistance between the wiring layer and the nano-metal layer without affecting the adhesion between the substrate and the nano-metal layer, which is beneficial for increasing the electric conductivity of the touch panel and improving the touch control effect of the touch panel, and the contact area between the wiring layer and the adhesion enhancement layer can therefore be appropriately reduced so that the size of the bezel area of the touch panel can be correspondingly reduced to meet the market demand for a narrow bezel of the display device.

### BRIEF DESCRIPTION OF THE DRAWINGS

FIG. 1 is a flowchart of a method of manufacturing a touch panel provided by Embodiment 1 of the present application;

FIG. 2 to FIG. 5 are schematic structural diagrams corresponding to the respective steps in the method of manufacturing the touch panel in Embodiment 1 of the present application;

FIG. 6 is a flowchart of a method of manufacturing a touch panel provided by Embodiment 2 of the present application;

FIG. 7 and FIG. 8 are schematic structural diagrams corresponding to the respective steps in the method of manufacturing the touch panel in Embodiment 2 of the present application.

### DETAILED DESCRIPTION OF THE INVENTION

As described in the background, the existing touch panels have unsatisfactory touch control effect and have difficulty in meeting the design requirement for a narrow frame. Conventional touch panels are limited in development towards flexibility due to problems such as brittleness, electric conductivity, and light transmittance, etc. of the ITO film thereof. At present, alternative materials to replace the ITO film have been developed in the industry, and among the alternative materials, metal nanowires have superior mechanical properties and excellent electric conductivity, and have excellent light transmittance and flexural endurance due to their nano-level size effects. Therefore, the metal nanowires can be used instead of the ITO film as the material for the touch electrodes. However, the existing touch panels using metal nanowires as touch electrodes have poor touch control effect and have difficulty in meeting the design requirement for a narrow bezel.

Research has found out that, this is because, during the manufacturing process of the touch panel with silver nanowires, a silver nanowire solution is usually directly coated on a substrate to form a silver nanowire conductive layer, however, the silver nanowires in the conductive layer are only lap jointed by weak intermolecular force, therefore, the bonding strength between the silver nanowire conductive layer and the substrate is poor, and slip shifting may easily occur during a bending process, which leads to a high and unstable electric resistance for the touch panel. An adhesion enhancement layer, which is usually an adhesion enhancement adhesive layer (a transparent insulating adhesive layer) such as an optical adhesive layer, may be further coated on the silver nanowire conductive layer, and the adhesion enhancement layer covers the silver nanowire conductive layer and is also adhered to the substrate, so that the adhesion between the silver nanowire conductive layer and the substrate can be improved. However, the adhesion enhancement layer coated on the silver nanowire conductive layer reduces the effective contact area between the silver nanowire conductive layer and the wiring layer formed on the adhesion enhancement layer, and increases the contact resistance between them, resulting in a degradation in the touch control effect of the touch panel. Therefore, on the basis of the above structure, in order to ensure the touch control effect of the touch panel, it is needed to expand the contact area between the silver nanowire conductive layer and the wiring layer, and the contact area determines the size of the bezel area of the touch panel. Therefore, the touch panel obtained in this way cannot meet the design requirement for a narrow bezel, and thus has difficulty in meeting the market demand for display devices.

Based on the above discovery, the present application provides a method of manufacturing a touch panel, an ion implantation process is performed to make an adhesion enhancement layer between the silver nanowire conductive layer and the wiring layer contain a conductive material, so that the adhesion enhancement layer between the two has electric conductivity. The adhesion enhancement layer with electric conductivity is capable of reducing the contact resistance between the wiring layer and the nano-metal layer, which is beneficial for increasing the electric conductivity of the touch panel, thereby improving the touch control effect of the touch panel. Moreover, since the adhesion enhancement layer with electric conductivity enhances the electric conductivity of the touch panel, the contact area between the wiring layer and the conductive layer can be appropriately reduced while maintaining the same electric conductivity, and the size of the bezel area of the touch panel can be correspondingly reduced. Therefore, the manufactured touch panel can meet the design requirement of a narrow bezel, thereby meeting the market demand for a narrow bezel of the display device.

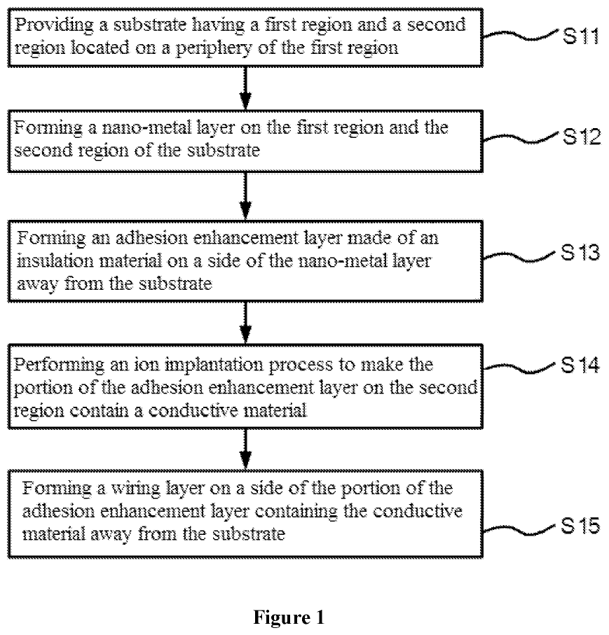

Embodiments of the touch panel, the manufacturing method thereof, and the display device will be described in detail with reference to FIG. 1 to FIG. 8, so as to clearly set forth the content of the present application.

### Embodiment 1

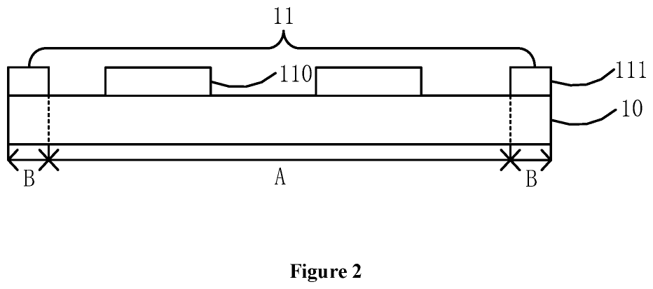

Please refer to FIG. 1 to FIG. 5, FIG. 1 is a flowchart of a method of manufacturing a touch panel provided by Embodiment 1, and FIG. 2 to FIG. 5 are schematic structural diagrams corresponding to the respective steps in the method of manufacturing the touch panel in Embodiment 1.

As shown in FIG. 1, the method of manufacturing the touch panel in this embodiment comprises:

Step S11, providing a substrate having a first region and a second region;

Step S12, forming a nano-metal layer on the first region and the second region of the substrate;

Step S13, forming an adhesion enhancement layer made of an insulation material on a side of the nano-metal layer away from the substrate; and;

Step S14, performing an ion implantation process to make the portion of the adhesion enhancement layer on the second region contain a conductive material; and

Step S15, forming a wiring layer on a side of the portion of the adhesion enhancement layer containing the conductive material away from the substrate.

FIG. 2 to FIG. 5 are referred to for further details. Firstly, step S11 is performed to provide a substrate 10 having a first area A and a second region B located on a periphery of the first region A, as shown in FIG. 2. The second region B surrounds the first region A, and the first region A generally corresponds to a visible area in the display screen for display with light transmission, and the second region B generally corresponds to an opaque bezel area in the display screen. For example, the substrate 10 is rectangular, and the second region B is located on the edge of the substrate A and has an annular shape.

Preferably, in the present embodiment, the substrate 10 is a flexible substrate, and the material of the flexible substrate may be, but not limited to, acryl, polymethyl methacrylate (PMMA), polyacrylonitrile-butadiene-styrene (ABS), polyamide (PA), polyimide (PI), polybenzimidazole polybutene (PB), polybutylene terephthalate (PBT), polycarbonate (PC), polyether ether ketone (PEEK), polyether imide (PEI), polyether sulfone (PES), polyethylene (PE), polyethylene terephthalate (PET), polyethylene tetrafluoroethylene (ETFE), poly-epoxyethane, polyglycolic acid (PGA), polymethylpentene (PMP), polyoxymethylene (POM), polyphenylene ether (PPE), polypropylene (PP), polystyrene (PS), polytetrafluoroethylene (PTFE), polyurethane (PU), polyvinyl chloride (PVC), polyvinyl fluoride (PVF), polyvinylidene chloride (PVDC), polyvinylidene fluoride (PVDF) or styrene-acrylonitrile (SAN), etc. In this embodiment, the flexible substrate is preferably made of polyimide.

Next, step S12 is performed to form a nano-metal layer 11 on the first region A and the second region B of the substrate 10, as shown in FIG. 2. Preferably, the nano-metal layer 11 may be made of, but not limited to, gold nanowires or silver nanowires. In this embodiment, the nano-metal layer 11 is preferably a silver nanowire layer, since the metal silver is in its normal state an opaque silver white metal with excellent electric conductivity. The silver nanowire layer contains silver nanowires with a length between 10 μm and 300 μm, a diameter (or a wire width) of less than 500 nm and a length-to-width ratio (a ratio of the length to the wire width) of greater than 10. A nano-metal solution is typically coated on the substrate 10, and the coating methods thereof include, but not limited to inkjet, spreading, gravure printing, embossed printing, flexographic printing, nano-imprinting, screen printing, scraper coating, spin coating, stylus plotting, seam coating or flow coating; then, a desired nano-metal layer 11 is formed by a patterning process, and the nano-metal 11 comprises a portion 110 of the nano-metal layer on the first region and a portion 111 of the nano-metal layer on the second region. In addition, an insulating layer (not shown) may be formed between the substrate 10 and the portion 110 of the nano-metal layer on the first region, which is not limited to this herein.

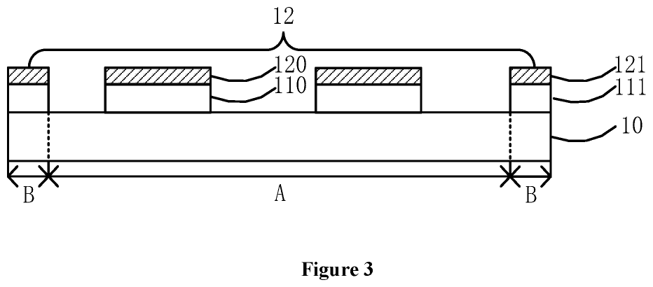

Then, step S13 is performed to form an adhesion enhancement layer 12 which is located on a side of the nano-metal layer 11 away from the substrate 10 and is formed by an insulating material, as shown in FIG. 3. Preferably, in order to enhance the adhesion between the nano-metal layer 11 and the substrate 10, the adhesion enhancement layer 12 is an adhesion enhancement adhesive layer, such as an optical adhesive layer, etc. The adhesion enhancement layer 12 comprises a portion 120 of the adhesion enhancement layer on the first region and a portion 121 of the adhesion enhancement layer on the second region. The adhesion enhancement layer 12 enables the silver nanowires to be better adhered to the substrate 10, so that the silver nanowires are less likely to shift relative to one another, and the lap-joint can be made firmer, thereby increasing the electric conductivity and sensitivity of the touch panel.

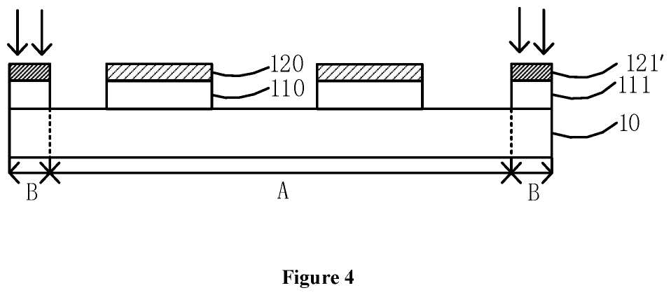

Next, step S14 is performed to perform an ion implantation process to make the adhesion enhancement layer on the second region contain a conductive material, as shown in FIG. 4. The ion implantation process is a technique of doping a region near a surface of a material, which can change the carrier concentration and electric conductivity type in the material, i.e., change the variation of the electronic state in the material. Preferably, the ion implantation process (doping) is performed by an ion implanter. The main component of the ion implanter is an ion source. The ion implanter utilizes hot electrons generated by the filament in the ion source and under the action of the electric field to bombard gas molecules to make the gas molecules ionized. If the doping source to be implanted is in a gaseous state (such as semiconductor gas: phosphine PH3, phosphorus trifluoride PF3, phosphorus pentafluoride PH5, arsine AsH3 or boron trifluoride BH3, etc., wherein, because As is an element with a large relative atomic mass, the element As is more effective in improving the electric conductivity of the adhesion enhancement layer 121 on the second region), it can be directly introduced into the electric field of the ion source. If the doping source is in a solid state (For example, a transition metal: gold, silver or copper, etc.), it can be heated and evaporated into gas phase and then introduced into the electric field of the ion source. The doping source in gas phase turns into ions (i.e., electrically charged atoms or molecules) after being ionized in the electric field. Then, the portion 121 of the adhesion enhancement layer on the second region is converted into a portion 121′ of the adhesion enhancement layer containing a conductive material (having electric conductivity) by the ion implantation process.

The ion implantation process can carry out doping in a predetermined region (i.e., in the portion 121 of adhesion enhancement layer on the second region) by using a mask, and the doping concentration can be adjusted by controllable energy adjustment to the doping source having the element to be implanted, or the doping concentration can be controlled by changing the dosage of the doping source having the element to be implanted, and the specific doping concentration range is not limited herein.

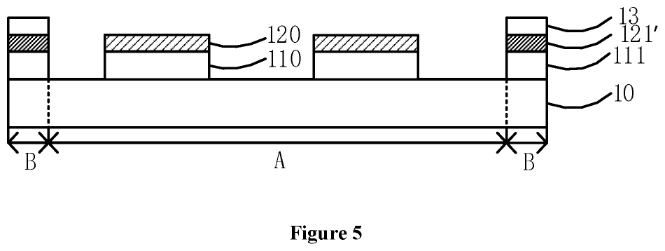

Then, step S15 is performed to form a wiring layer 13 on a side of the portion 121′ of the adhesion enhancement layer containing the conductive material (having electric conductivity) away from the substrate 10, as shown in FIG. 5. Preferably, the wiring layer 13 can be made of gold wires or silver wires. The wiring layer 13 can be formed in ways including, but not limited to, printing (such as gravure printing, embossed printing, flexographic printing, transfer printing, etc.), sputtering or evaporation coating. The wiring layer 13 is used as interconnection lines for the touch electrodes, and the area of the wiring layer 13 corresponds to the size of the bezel area of the touch panel. Since the portion 121 of the adhesion enhancement layer between the wiring layer 13 and the nano-metal layer 11 has been converted into a portion 121′ of the adhesion enhancement layer having electric conductivity (containing a conductive material), the portion 121′ of the adhesion enhancement layer having electric conductivity can reduce the contact resistance between the wiring layer 13 and the nano-metal layer 11, which is advantageous for increasing the electric conductivity of the touch panel, thereby improving the touch control effect of the touch panel. Furthermore, because the electric conductivity of the touch panel is enhanced by the portion 121′ of the adhesion enhancement layer having electric conductivity, a contact area between the wiring layer 13 and the portion 121′ of the adhesion enhancement layer with electric conductivity can be reduced appropriately while maintaining the same electric conductivity, and the size of the bezel area of the touch panel can be reduced correspondingly. Therefore, the touch panel can meet the design requirement for a narrow frame, thereby meeting the market demand for a narrow frame of the display device.

Correspondingly, the touch panel formed by the above manufacturing method comprises a substrate 10 having a first region A and a second region B located on a periphery of the first region A; a nano-metal layer 11 located on the first region A and the second region B of the substrate 10; an adhesion enhancement layer 12 located on a side of the nano-metal layer 11 away from the substrate and comprising a portion 120 of the adhesion enhancement layer on the first region and a portion 121′ of the adhesion enhancement layer on the second region, and the portion 121′ of the adhesion enhancement layer on the second region contains a conductive material (having electric conductivity); a wiring layer 13 located on a side of the portion 121′ of adhesion enhancement layer on the second region away from the substrate 10, as shown in FIG. 5. Therefore, the portion 121′ of the adhesion enhancement layer having electric conductivity can reduce the contact resistance between the wiring layer 13 and the nano-metal layer 11, which is advantageous for increasing the electric conductivity of the touch panel, thereby improving the touch control effect of the touch panel. Furthermore, since the electric conductivity of the touch panel is enhanced by the portion 121′ of the adhesion enhancement layer having electric conductivity, a contact area between the wiring layer 13 and the portion 121′ of the adhesion enhancement layer with electric conductivity can be reduced appropriately while maintaining the same electric conductivity, and the size of the bezel area of the touch panel can be reduced correspondingly. Therefore, the touch panel can meet the design requirement for a narrow bezel, thereby meeting the market demand for a narrow bezel of the display device.

Apparently, the touch panel is not limited to being obtained by the above manufacturing method, and for instance, the touch panel may also be obtained by the following manufacturing method.

### Embodiment 2

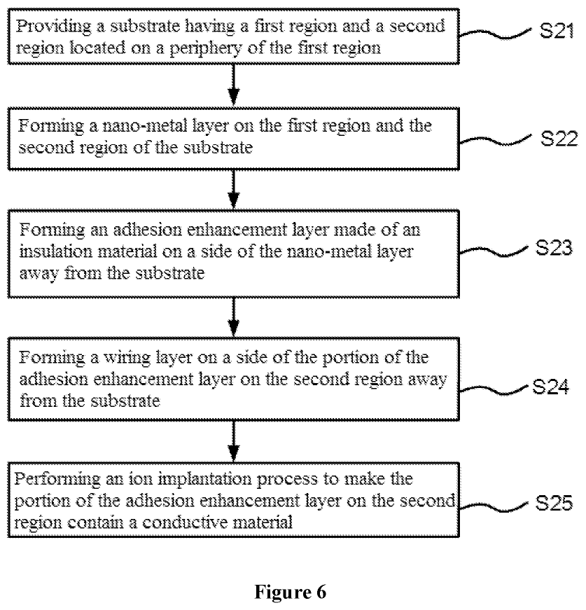

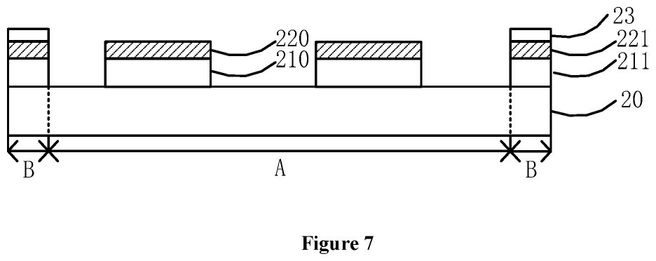

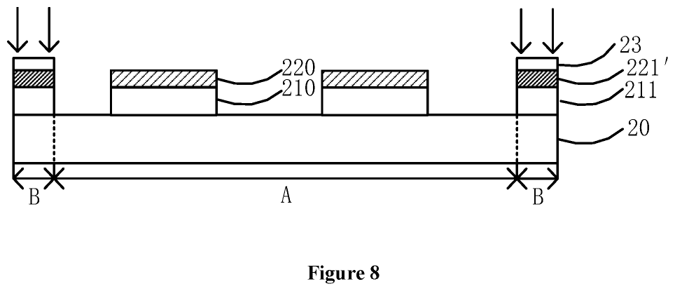

Referring to FIG. 6 to FIG. 8, wherein FIG. 6 is a flowchart showing a method of manufacturing a touch panel provided by Embodiment 2. FIG. 7 and FIG. 8 are structural schematic diagram corresponding to the respective steps in the method of manufacturing the touch panel in Embodiment 2.

As shown in FIG. 6, the method of manufacturing the touch panel in Embodiment 2 comprises:

Step S21, providing a substrate having a first region and a second region located on a periphery of the first region;

Step S22, forming a nano-metal layer on the first region and the second region of the substrate;

Step S23, forming an adhesion enhancement layer made of an insulation material on a side of the nano-metal layer away from the substrate;

Step S24, forming a wiring layer on a side of the portion of the adhesion enhancement layer on the second region away from the substrate;

Step S25, performing an ion implantation process to make the portion of the adhesion enhancement layer on the second region contain a conductive material.

Specifically, the processes of the steps S21, S22 and S23 in Embodiment 2 are the same as those in the steps S11, S12 and S13 in Embodiment 1, i.e., the nano-metal layer and the adhesion enhancement layer are sequentially formed on the substrate 20, wherein the nano-metal layer comprises a portion 210 of the nano-metal layer on the first region and a portion 211 of the nano-metal layer on the second region, and the adhesion enhancement layer comprises a portion 220 of the adhesion enhancement layer on the first region and a portion 221 of the adhesion enhancement layer on the second region, as shown in FIG. 7, which is not repeatedly described herein.

Next, after finishing the above steps, the method continues to perform the step S24 to form a wiring layer 23, which is located on one side of the portion 221 of the adhesion enhancement layer on the second region away from the substrate 20, as shown in FIG. 7. Preferably, the material of the wiring layer 23 may also be gold wires or silver wires. The wiring layer 23 may be formed in ways including, but not limited to printing (for example, gravure printing, embossed printing, flexographic printing, transfer printing, etc.), sputtering or evaporation coating. The wiring layer 23 serves as interconnection lines for the touch electrodes, and the area of the wiring layer 23 corresponds to the size of the bezel area of the touch panel.

Finally, Step S25 is carried out by performing an ion implantation process to make the portion 221 of the adhesion enhancement layer on the second region contain a conductive material, as shown in FIG. 8. Specifically, regarding the ion implantation process, reference can be made to the description of Embodiment 1. It can be understood by a person skilled in the art that, in Embodiment 2, the ion implantation process directly acts on the wiring layer 23, therefore on the basis of Embodiment 1, it is necessary in Embodiment 2 to increase the implantation energy from the ion implanter or increase the dosage of the implantation doping source so as to achieve a deeper doping, so that the portion 221 of the adhesion enhancement layer beneath the wiring layer 23 can be converted into a portion 221′ of the adhesion enhancement layer containing a conductive material, which is not redundantly described herein.

Similarly, in Embodiment 2, since the portion 221 of the adhesion enhancement layer between the wiring layer 23 and the nano-metal layer 21 is converted into a portion 221′ of the adhesion enhancement layer having electric conductivity, the portion 221′ of the adhesion enhancement layer having electric conductivity can reduce the contact resistance between the wiring layer 23 and the nano-metal layer 21, which is advantageous for increasing the electric conductivity of the touch panel, thereby improving the touch control effect of the touch panel. Furthermore, since the electric conductivity of the touch panel is enhanced by the portion 221′ of the adhesion enhancement layer having electric conductivity, a contact area between the wiring layer 23 and the portion 221′ of the adhesion enhancement layer with electric conductivity can be reduced appropriately while maintaining the same electric conductivity, and the size of the bezel area of the touch panel can be reduced correspondingly. Therefore, the touch panel can meet the design requirement for a narrow bezel, thereby meeting the market demand for a narrow bezel of the display device.

In summary, in the method of manufacturing the touch panel of the present application, the ion implantation process is performed to make the portion of the adhesion enhancement layer on the second region contain a conductive material, and the contact resistance between the wiring layer and the nano-metal layer can be reduced without affecting the adhesion between the substrate and the nano-metal layer, which is advantageous for increasing the electric conductivity of the touch panel, thereby improving the touch control effect of the touch panel. Furthermore, since the portion of the adhesion enhancement layer on the second region contains a conductive material to enhance the electric conductivity of the touch panel, a contact area between the wiring layer and the adhesion enhancement layer can be reduced appropriately while maintaining the same electric conductivity, and the size of the bezel area of the touch panel can be reduced correspondingly. Therefore, the touch panel can meet the design requirement for a narrow bezel, thereby meeting the market demand for a narrow bezel of the display device.

1. A touch panel, comprising:
a substrate, having a first region and a second region located on a periphery of the first region;
a nano-metal layer, located on the first region and the second region of the substrate;
an adhesion enhancement layer, located on a side of the nano-metal layer away from the substrate and comprising a portion of the adhesion enhancement layer on the first region and a portion of the adhesion enhancement layer on the second region; and
a wiring layer, located on a side of the portion of the adhesion enhancement layer on the second region away from the substrate;
wherein the portion of the adhesion enhancement layer on the second region contains a conductive material.

2. The touch panel according to claim 1, wherein the portion of the adhesion enhancement layer on the second region is an adhesion enhancement adhesive layer.

3. The touch panel according to claim 2, wherein the adhesion enhancement adhesive layer is an optical adhesive layer.

4. The touch panel according to claim 1, wherein the nano-metal layer is a silver nanowire layer.

5. The touch panel according to claim 1, wherein the portion of the adhesion enhancement layer on the second region is made to contain a conductive material by an ion implantation process.

6. The touch panel according to claim 5, wherein an implanted element of the ion implantation process is selected from at least one of a transition metal element, a Group III element, and a Group V element.

7. The touch panel according to claim 6, wherein the implanted element is selected from at least one of gold, silver, copper, boron, phosphorus, and arsenic.

8. The touch panel according to claim 7, wherein the implanted element is arsenic.

9. A display device, comprising the touch panel according to claim 1.

10. A method of manufacturing a touch panel, comprising:
providing a substrate having a first region and a second region located on a periphery of the first region;
forming a nano-metal layer on the first region and the second region of the substrate;
forming an adhesion enhancement layer made of an insulation material on a side of the nano-metal layer away from the substrate; and
forming a wiring layer on a side of a portion of the adhesion enhancement layer on the second region away from the substrate; and
performing an ion implantation process to make the portion of the adhesion enhancement layer on the second region contain a conductive material.

11. The method according to claim 10, wherein the ion implantation process to make the portion of the adhesion enhancement layer on the second region contain a conductive material is performed before forming the wiring layer.

12. The method according to claim 10, wherein the ion implantation process to make the portion of the adhesion enhancement layer on the second region contain a conductive material is performed after forming the wiring layer.

13. The method according to claim 10, wherein the portion of the adhesion enhancement layer on the second region is an adhesion enhancement adhesive layer.

14. The method according to claim 13, wherein the adhesion enhancement adhesive layer is an optical adhesive layer.

15. The method according to claim 10, wherein the nano-metal layer is a silver nanowire layer.

16. The method according to claim 10, wherein an implanted element of the ion implantation process is selected from at least one of a transition metal element, a Group III element, and a Group V element.

17. The method according to claim 16, wherein the implanted element is selected from at least one of gold, silver, copper, boron, phosphorus, and arsenic.

18. The method according to claim 17, wherein the implanted element is arsenic.

19. The method according to claim 10, wherein a doping concentration of the conductive material in the portion of the adhesion enhancement layer on the second region is controlled by a controllable energy adjustment to a doping source comprising an element to be implanted or by changing a dosage of a doping source comprising an element to be implanted.
